(19) United States
(12) Patent Application Publication
(10) Pub. No.: US 2003/0170154 A1
(43) Pub. Date: Sep. 11, 2003

(54) Plasma assisted catalytic treatment of gases

(76) Inventors: Michael Inman, Oxfordshire (GB); Roy McAdams, Oxfordshire (GB); Peter James Andrews, Oxfordshire (GB); Martin Harte, Oxfordshire (GB)

Correspondence Address: Law Offices Of William H Holt, Unit 2 First Floor, 1423 Powhatan Street, Alexandria, VA, 22314, US

(21) Appl. No.: 10/362,176

(22) PCT Filed: Aug. 6, 2001
(86) PCT No.: PCT/GB01/03530

(30) Foreign Application Priority Data
Sep. 14, 2000 (GB) 0022627.4

(51) Int. Cl. B01J 19/08

(52) U.S. Cl. 422/186.04

(57) ABSTRACT

A reactor (100) for the plasma assisted treatment of effluent gases such as exhaust from internal combustion engines, and effluent gases from industrial processes and incineration. The reactor includes a stage for the plasma-assisted processing of noxious components in the effluent, such as carbonaceous combustion products from internal combustion engines. A diverter valve (119) is provided for bypassing at least that stage should it become blocked, for example by untreated carbonaceous combustion products. In a particular form of the reactor the treatment stages are modular in form.

The present invention relates to reactors for the plasma-assisted treatment of gaseous media and in particular to the reduction of the emissions of one or more of nitrogeneous oxides, particulate including carbonaceous particulate, hydrocarbons including polyaromatic hydrocarbons, carbon monoxide, sulphur oxides, dioxins, furans and other regulated or unregulated combustion products. Such products are encountered in the exhausts of internal combustion engines, or effluent gases from incineration or other industrial processes, such as from the pharmaceutical, food processing, paint manufacturing, dye manufacturing, textiles, printing and incineration industries.

One of the major problems associated with the development and use of internal combustion engines is the noxious exhaust emissions from such engines. Two of the most deleterious materials, particularly in the case of diesel engines, are particulate matter (primarily carbon) and oxides of nitrogen (NOₓ). Excessive levels of NOₓ also are produced by spark-ignition engines operating in what is known as ‘lean burn’ mode in which the air/fuel ratio is higher than that required for stoichiometric combustion. Increasingly severe emission control regulations are forcing internal combustion engine and vehicle manufacturers to find more efficient ways of removing these materials in particular from internal combustion engine exhaust emissions. Unfortunately, in practice, it is found that combustion control-techniques which improve the situation in relation to one of the above components of internal combustion engine exhaust emissions tend to worsen the situation in relation to the other.

A variety of systems for trapping particulate emissions from internal combustion engine exhausts have been investigated, particullarly in relation to making such particulate emission traps capable of being regenerated when they have become saturated with particulate material.

Examples of such dieseel exhaust particulate filters are to be found in Europeann patent application EP 0 010 384, m U.S. Pat. Nos. 4,505,107; 4,485,622; 4,427,418; and 4,276,066; EP 0 244 061; EP 0 112 634 and EP 0 132 166. In a broader context, the porecipitation of charged particulate matter by electrostatic forces also is known. However, in this case, preccipitation usually takes place upon large planar electrodees or metal screens.

GB patent 2,274,412 diiscloses a method and apparatus for removing particulate annd other pollutants from internal combustion engine exhaust gases. In addition to removing particulates by electric discharge assisted oxidation, such as by use oof a non-thermal plasma, there is disclosed the reduction of NOₓ, gases to nitrogen, by the use of a bed of pellets adapted to catalyse the NOₓ reduction.

However, to date no one material has been found to be completely effective for the removal from internal combustion engine exhausts of emissions such as carbonaceous and nitrogenous combustion products and interest has turned to two-stage systems.

U.S. Pat. No. 4,902,487 and the article by Cooper and Thoss ‘Role of NO in Diesel Particulate Emission Control’ published as SAE 890404, 19 89 describes a two-stage system in which diesel-exhaust is passed over an oxidation catalyst, Pt, that oxidises NO in the exhaust gas to NO₂ after which NO₂ reacts with carbonaceous particulates in the exhaust stream that are trapped on a filter. The NO₂ effectively combusts the deposited carbon particulates and is thus reduced and products of this reaction are NO, N₂, CO and CO₂. A combustion catalyst for example a lanthanum oxide, caesium oxide doped vanadium pentoxide on the filter is used to lower the combustion temperature of the carbon/NO₂, reaction to around 265° C.

Multi-stage systems have been extended from use of wholly thermal catalysts to a combination of a non-thermal plasma and a catalyst for treatment of NOₓ components of diesel exhausts. GB Patent Application 2,270,013 A describes a two-stage system in which exhaust emissions from internal combustion engines are subject to a low temperature plasma and then passed over a catalyst that is downstream of the plasma. Although not specifically mentioned in GB 2,270,013 A it will be appreciated that the exhaust emissions can contain nitrogen oxides. U.S. Pat. No. 5,711,147 describes a two-stage system in which a non-thermal plasma oxidises NO in a gas stream to NO₂ and the latter then undergoes selective catalytic reduction to N₂ in the presence of C₃H₆ over a γ-Al₂O₃ catalyst. The system is for use with oxygen-rich exhaust gases from diesel and lean-burn spark ignition engines. In the system described a hydrocarbon such as diesel fuel is cracked into simpler hydrocarbons by a corona discharge and mixed with oxygen-rich exhaust gases from which NOₓ is to be removed. The mixed hydrocarbons and exhaust gases are then passed through another region of corona discharge, which may include silica beads as a particulate trap. In this region, NOₓ is oxidised to NO₂. The NO₂ plus excess hydrocarbons are passed through a bed of a catalyst which acts to reduce the NO₂ to O₂ and N₂ and to oxidise the hydrocarbons to CO₂ and H₂O. No plasma is involved in the reduction stage. There is a requirement for pre-conversion of NO to NO₂ before selective catalytic reduction in U.S. Pat. No. 5,711,147 as the catalyst is more efficient for NO₂ reduction than NO reduction. In addition sufficient hydrocarbons have to be present to enhance plasma oxidation of NO to NO₂ and to act as a reductant for reduction of NO₂ to N₂. WO00/18494 describes a method and apparatus in which a gas stream containing NO and hydrocarbon is passed through a plasma and then over a catalyst comprising a microporous material particularly a zeolite resulting in reduction of NOₓ to nitrogen. Results shown in WO 00/18484 indicate that the percentage NOₓ reduction was as high as 77% but could be as low as 4% depending on the catalyst used for a temperature in the range 100-300° C.

WO 00/43102 and U.S. Pat. No. 6,038,854 describe apparatus in which a non-thermal plasma oxidises the NO component of exhaust gases to NO₂ after which in a second stage the NO₂ oxidises carbon particulates in the exhaust.

It is an object of the present invention to provide practicable reactors for the multi-stage treatment of the exhaust emissions from internal combustion engines, or effluent gases from industrial processes and incineration to reduce the emission of noxious components therein. A particular object of the invention, in the case of internal combustion engines, is to reduce the emission of carbonaceous and nitrogen oxide combustion products therefrom.

According to the present invention there is provided a reactor for the plasma-assisted processing of effluent gases such as exhaust gases from an internal combustion engine or effluent gases from industrial processes or incineration to reduce the emission of noxious combustion products therefrom, comprising a reactor chamber adapted to be connected to a source of effluent gas and including a central axial duct at least a portion of which is gas permeable, a first gas permeable bed of a material adapted to perform a first stage treatment including where necessary the removal of carbonaceous combustion products from gases passing therethrough, the said first gas permeable bed surrounding the gas permeable region of the central duct, means for establishing a non-thermal plasma in gases in the interstices of the first gas permeable bed, and also surrounding the axial duct at least one other gas permeable bed of a material adapted to catalyse the reduction of nitrogen oxides in gases passing therethrough and a flow diverter adapted in one state to constrain gases to pass initially through the first region of active material surrounding the central duct and then through at least one other region of active material surrounding the central duct and in a second state to allow the gases to pass directly through the central duct of the reactor.

At least one other bed of a gas permeable material adapted to catalyse the reduction of nitrogen oxides in gases passing therethrough may surround the said first region or be situated axially downstream thereof.

Preferably the said first gas permeable bed of active material is provided by a plurality of modules disposed regularly around the central duct and connected in parallel electrically, the number of modules being determined by the flow rate of the gases, the concentration of emissions, the geometric space available for housing the reactor and the degree of remediation required.

The said at least one other bed of gas permeable active material also may be modular in form, each module being associated with a module of the said first gas permeable bed of active material.

The means for exciting a non-thermal plasma in the interstices of the first bed of active material may comprise an array of dielectric tubes coated internally with a metallised layer that can be deposited electrolytically and that can be made of, but is not restricted to, a suitable conducting material such as silver, nickel or copper and connected in parallel to a source of high electric potential, the tubes being sufficiently close to act effectively as if together they comprised a single dielectric coated electrode. Painting or printing a silver-based paste followed by a calcination step can also be used for metallisation. Preparation of a metallised layer is described in WO00/71866. Alternatively, the means for exciting a non-thermal plasma in the interstices of the first bed of active material may comprise one or more cylindrical gas permeable electrodes buried in the first bed of active material.

The flow diverter may comprise a butterfly or gate valve so arranged that when it is closed the exhaust gases are constrained to pass through the beds of active material with at least a radial component of flow and when it is open the exhaust gases can pass directly through the central duct in the reactor chamber.

Suitable materials for the first bed of active material are dielectric, preferably ferroelectric materials such as those disclosed in our pat. 2, 274, 412 or co-pending application WO99/12638. Other suitable materials for the first bed of active materials are vanadates and perovskites as described in WO99/38603 and PCT/GB01/00442 filed on 02 Feb. 2001, alkali metal doped lanthanum oxide-vanadium oxides and cerium oxides described in WO00/43102.

Suitable materials for the other bed, or beds, of active material are activated aluminas, with or without catalytically active metals such as silver or molybdenum included in them. Such materials are disclosed in our co-pending application PCT/GB00/01571 filed 5^{th} Apr. 2001. Other suitable materials for the other beds are zeolite materials, metal doped aluminas including the zeolites ZSM-5, Y, beta, mordenite all of which may contain iron, cobalt or copper with or without additional catalyst promoting cations such as cerium and lanthanum. Other examples of zeolites are alkali-metal containing zeolites such as sodium-Y zeolites that are particularly useful for treatment of nitrogeneous oxides as well as ferrierites and silver containing ferrierites containing up to 10 weight percent silver that are also particularly useful materials for the removal of nitrogen oxides.

Preferably the material in the first bed is particulate in the form of spheres, pellets, extrudates, sheets, wafers, frits, meshes, coils, granules or combinations of these shapes as this facilitates intimate electrical contact between the material and the high-voltage plasma excitation electrodes.

The material in the other bed, or beds, also may be particulate in form but may be in the form of spheres, pellets, extrudates, sheets, wafers, frits, meshes, coils, granules, membranes, foam, ceramic honeycomb monolith or as a coating on any of these shapes or combinations of these shapes.

The invention will now be described with reference to the accompanying drawings, in which

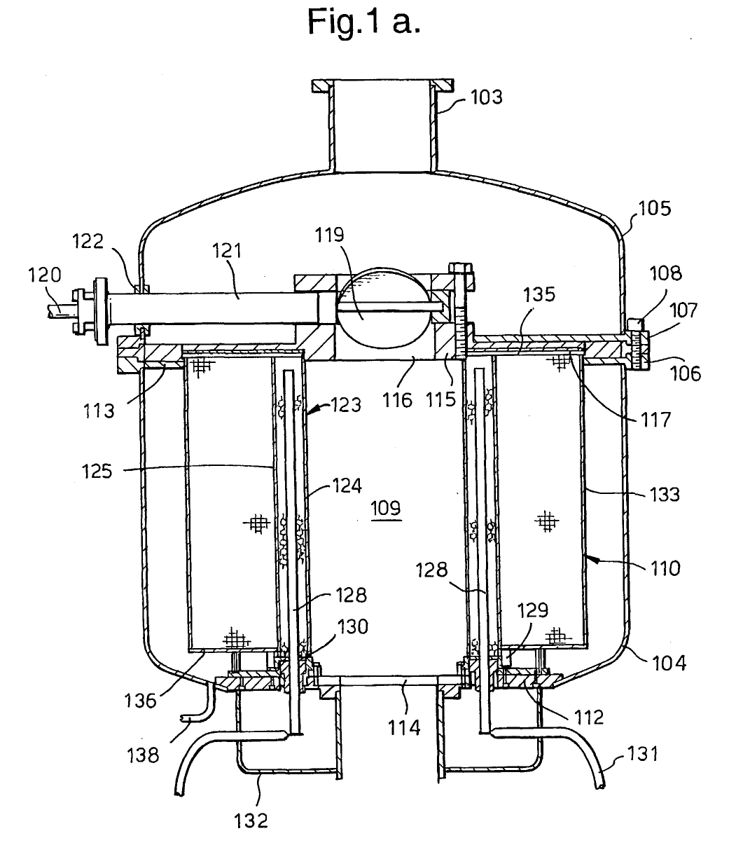

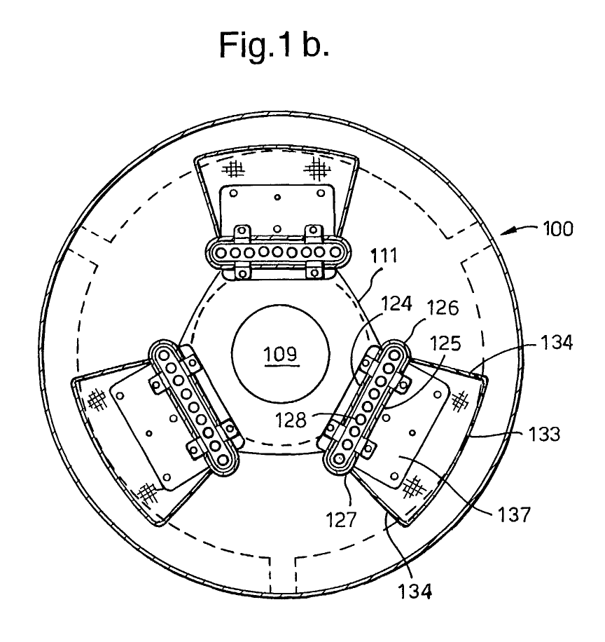

FIG. 1 shows transverse and longitudinal sectional views of an embodiment of the invention;

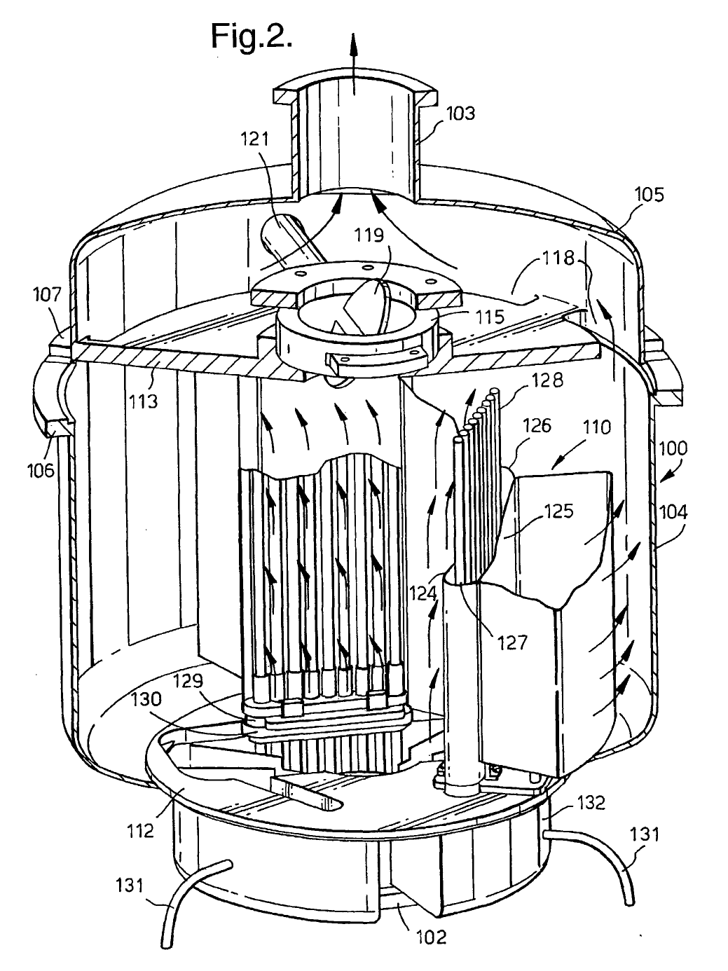

FIG. 2 is a part-sectional three-dimensional view of the embodiment of the invention illustrated in FIG. 1 showing the gas flow pattern therein;

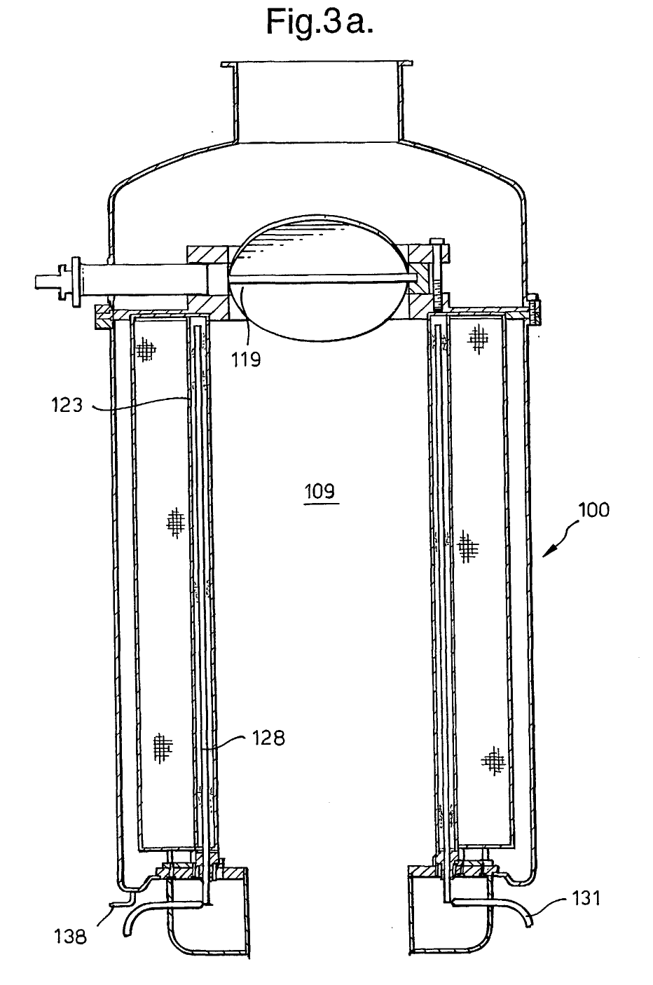

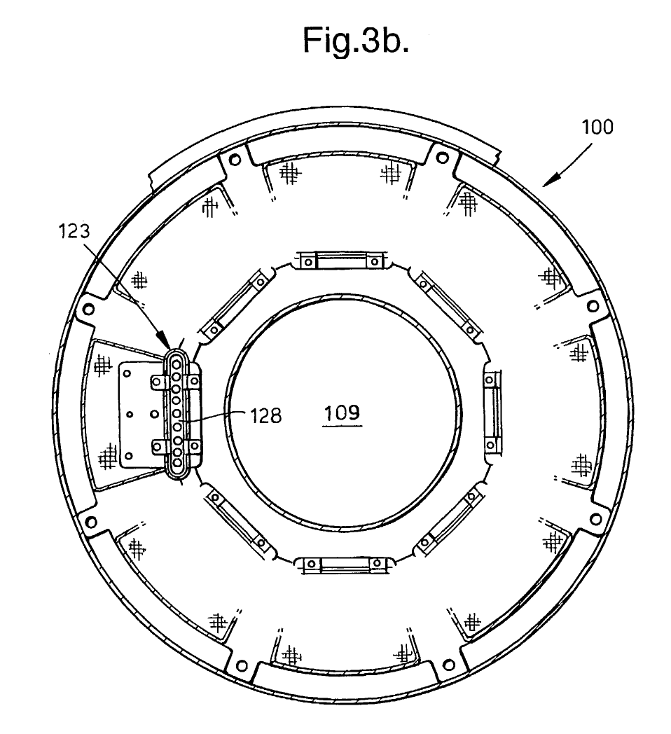

FIG. 3 is a transverse and longitudinal sectional view of a second embodiment of the invention;

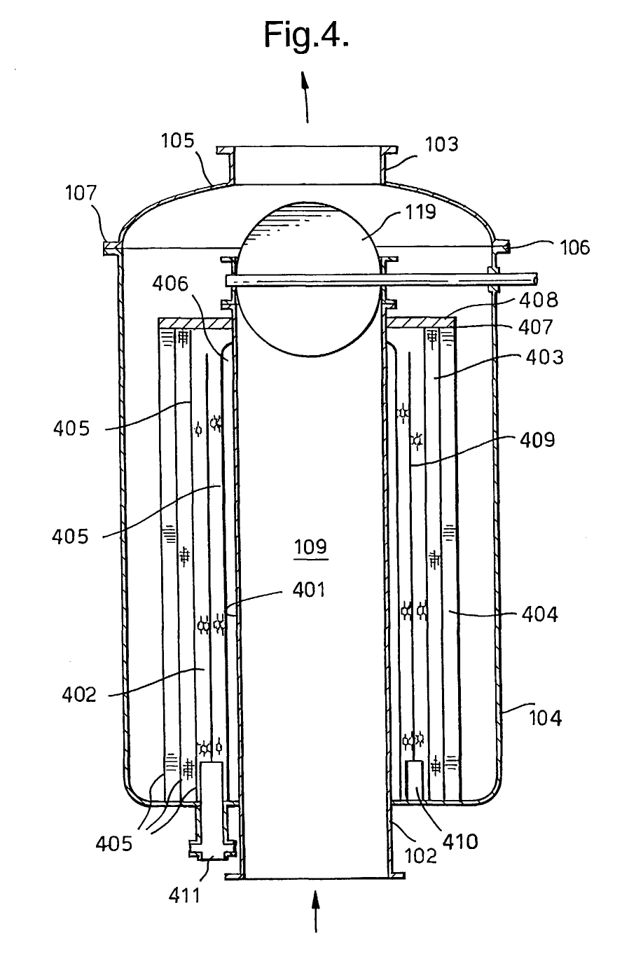

FIG. 4 is a longitudinal sectional view of a third embodiment of the invention;

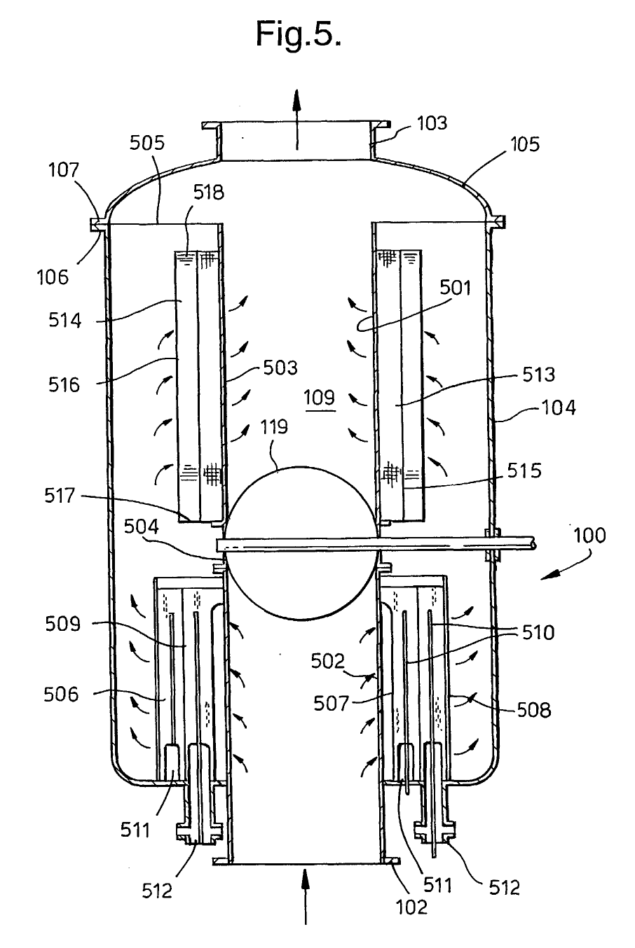

FIG. 5 is a transverse and longitudinal sectional view of a fourth embodiment of the invention;

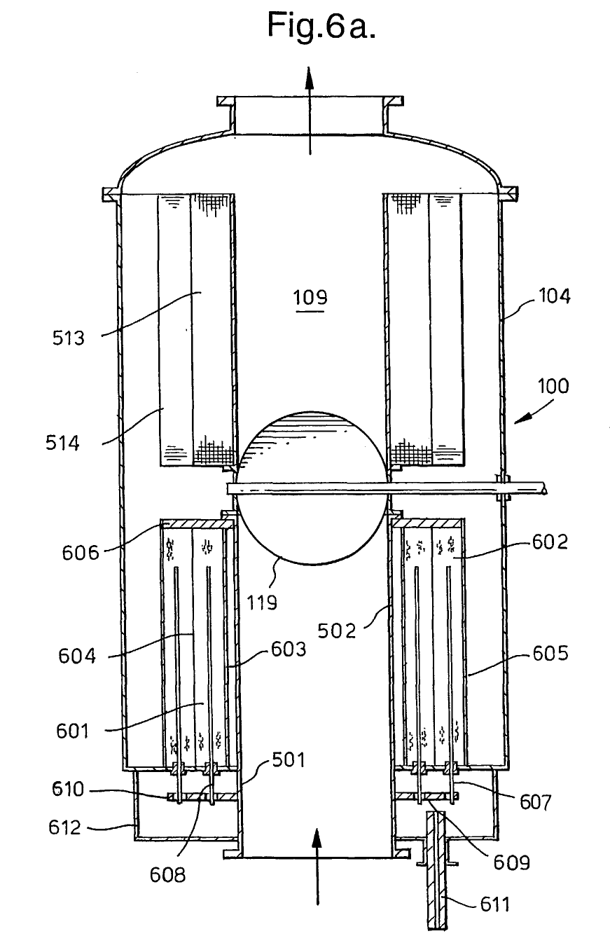

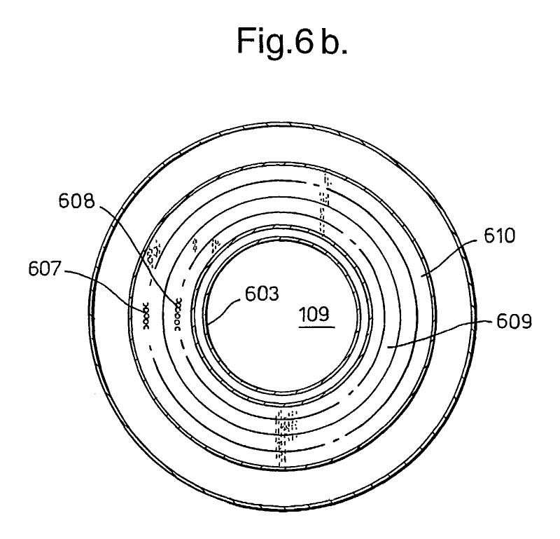

FIG. 6 is a transverse and longitudinal sectional view of a fifth embodiment of the invention;

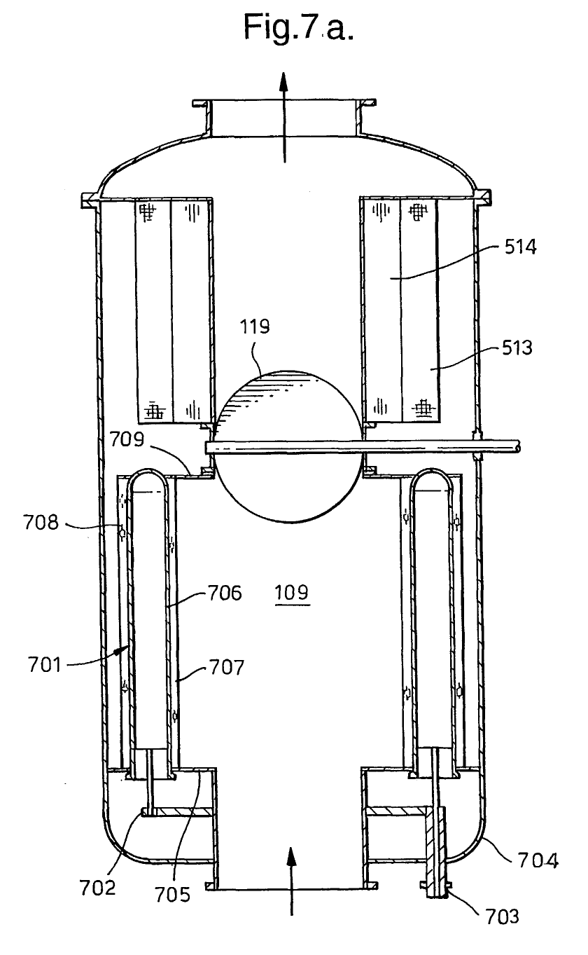

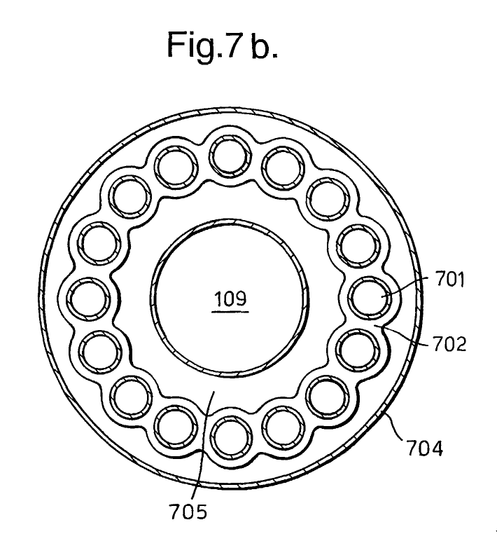

FIG. 7 is a transverse and longitudinal sectional view of a sixth embodiment of the invention;

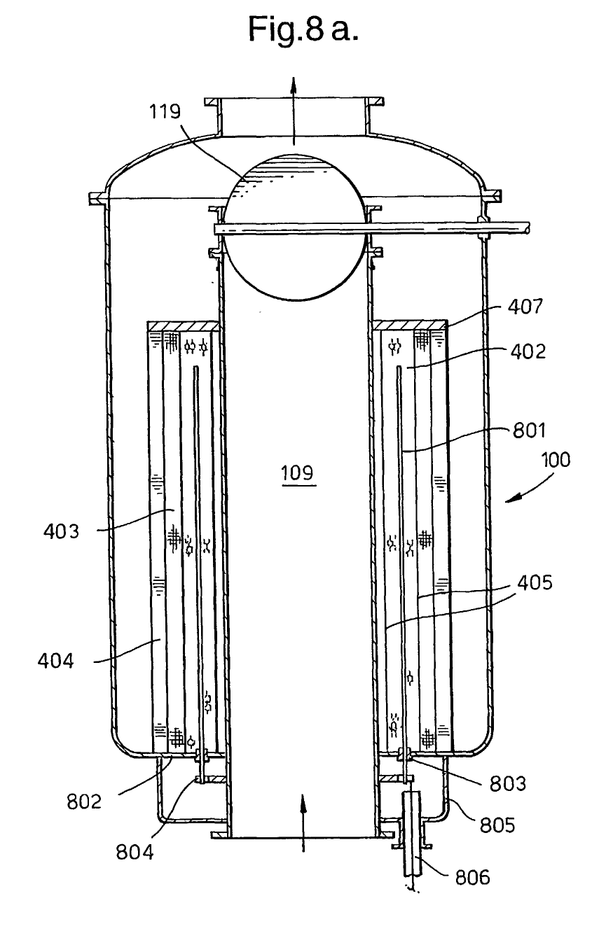

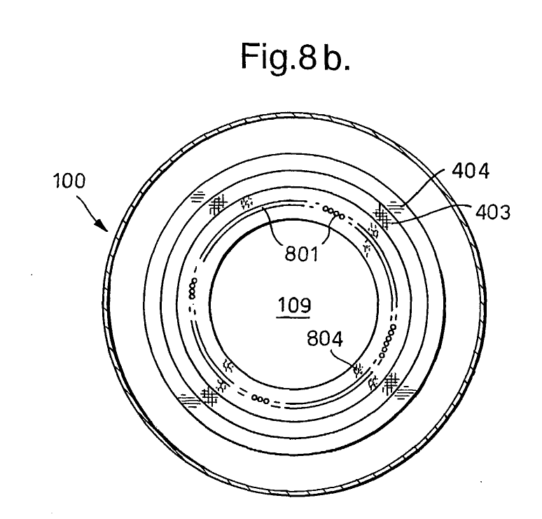

FIG. 8 is a transverse and longitudinal sectional view of a seventh embodiment of the invention.

Referring to FIG. 1 of the drawings, a reactor for the treatment of the exhaust gases from an internal combustion engine, particularly a diesel engine, to remove carbonaceous combustion products and nitrogen oxides therefrom comprises a cylindrical reactor chamber 100 which has inlet and outlet stubs 102 and 103, respectively, by means of which it can be incorporated into the exhaust system of an internal combustion engine. The chamber 100 is in two sections, 104, 105 which are joined together by sealed flanges 106, 107 and set screws 108.

Inside the reactor chamber 100 there is a central duct 109 which is formed by three regularly spaced plasma/catalyst modules 110 and bridging sections 111. The assembly is held in position by two support members 112, 113 respectively. The support member 112 has a central orifice 114 but otherwise is gas-tight. The support member 113 has a central boss 115 which has an axial orifice 116. The support member 113 also has a series of recesses 117 into which the plasma/catalyst modules 110 fit and a number of peripheral slots 118 which are not visible in the drawing. Mounted in the boss 115 is a flow diverter valve in the form of a butterfly valve 119. The operating spindle 120 of the butterfly valve 119 is protected by a sleeve 121 which passes through the wall of the section 105 of the reactor chamber 100. A gas-tight seal is provided by a grommet 122. The support 113, diverter valve assembly and sealing grommet 122 are made of materials which are capable of withstanding the operating temperature of the exhaust gases passing through the reactor, such as stainless steel.

Each of the plasma/catalyst modules 110 consists of a plasma section having a stainless steel envelope 123 which has two opposed wall sections 124, 125 which are perforated, and two semi-cylindrical end sections 126, 127 which are not perforated. Positioned along the longitudinal axis of the envelope 123 are nine tubes 128 made of a ceramic material such as alumina. The insides of the tubes 128 are coated with a high-conductivity metal such as silver. The tubes 128 are aligned with one another and spaced apart by approximately 10 mm to permit passage of gaseous medium therebetween. In this way the tubes 128 are sufficiently close together effectively to form one electrode of a dielectric barrier discharge reactor the other electrode of which is formed by the envelope 123 of the plasma section of the plasma/catalyst modules 110, which is connected to an earth point, not shown in the drawing. The upstream ends of the ceramic tubes 128 project through a closure member 129 via an insulated feed through 130 and are connected in parallel to an high voltage power supply, not shown in the drawing, via feed cables 131 which are covered by a shroud 132. The plasma section of the plasma/catalyst module 110 is packed with beads or pellets 132a made of a dielectric material that can include a ferroelectric material such as a titanate or zirconate or other of the materials disclosed in our patent GB 2,274,412 or co-pending application WO99/12638. Other suitable materials are vanadates, perovskites and other carbon combustion catalysts such as alkali metal doped lanthanum oxide-vanadium oxide and combinations of these materials. The outer perforated section 125 of the plasma section of the plasma/catalyst module 110 forms the inner wall of a sector-shaped catalyst section of the plasma/catalyst module 110. The outer arcuate wall 133 of the catalyst section of the plasma/catalyst module 110 also is made of perforated stainless steel.

The radial walls 134 of the catalyst section of the plasma/catalyst module are made of unperforated stainless steel.

The downstream end of both sections of the plasma/catalyst module 110 are closed by a stainless steel end plate 135. The upstream end of the catalyst section of the plasma/catalyst module 110 is closed by a stainless steel end plate 136 to which is attached a mounting/support bracket 137, which in turn is attached to the support 112. The catalyst section of the plasma/catalyst module 110 is filled with pellets of a material such as an activated alumina containing silver or molybdenum, which in the presence of plasma activated exhaust gases passing into the catalyst section of the plasma/catalyst module 110 from the plasma section thereof, catalyses the reduction of NOₓ to N₂. The concentration of silver or molybdenum is sufficient for promoting catalytic reduction of nitrogen oxides to nitrogen but low enough to avoid production of unwanted species such as nitrous oxide. For silver, 2% Ag is a suitable concentration. Other catalytic materials are zeolite materials, metal doped aluminas including the zeolites ZSM-5, Y, beta, mordenite all of which may contain iron, cobalt or copper with or without additional catalyst promoting cations such as cerium and lanthanum. Other examples of zeolites are alkali-metal containing zeolites such as sodium-Y zeolites that are particularly useful for treatment of nitrogeneous oxides as well as ferrierites and silver containing ferrierites containing up to 10 weight percent silver that are also particularly useful materials for the removal of nitrogen oxides. Indium doped zeolites can be used and ion exchange can be used for introducing metal into the zeolite.

Alternatively, the bed of catalytic material can be in the form of a gas permeable monolithic body of spheres, pellets, extrudates, sheets, wafers, frits, meshes, coils, granules, membranes, foam, ceramic honeycomb monolith or as a coating on any of these shapes.

The section 104 of the reactor chamber 100 is provided with a drain cock 138 for the removal of liquid condensates from the reactor chamber 100. AS the reactor illustrated is intended to be mounted vertically, the drain cock 138 is positioned in the lower end wall of the section 104 of the reactor chamber 100. For horizontally mounted reactors a similar drain cock can be provided in the cylindrical part of the wall of the reactor chamber 100.

In use, initially the diverter valve 119 is closed, which causes the exhaust gases to flow radially through the plasma sections of the plasma/catalyst modules 110, being excited into a non-thermal plasma state therein, and then through the catalyst sections of the plasma/catalyst modules 110, before passing through the peripheral slots into the support 113 and out of the outlet 103 from the reactor chamber 100, in the manner shown in FIG. 2. The back-pressure in the exhaust system is monitored and if it shows a significant rise, indicating that at least the plasma sections of the plasma/catalyst modules 110 are becoming blocked with trapped particulate carbonaceous combustion products which have not been oxidized in the plasma sections of the plasma/catalyst modules 110, then the diverter valve 119 is opened, allowing the exhaust gases to by-pass the plasma/catalyst modules 110 and the engine to operate at its full capability until such time as the reactor 100 can be cleaned of the carbonaceous combustion products.

It will be appreciated that the plasma section is able to remove not only carbonaceous particulate but other noxious components of the exhaust gases from internal combustion engines but when emissions are derived from other processes additional noxious components can be removed. Hence, in incineration processes, dioxins and furans are removed by the plasma.

FIG. 3 illustrates a second form of reactor in which there are eight plasma/catalyst modules 110. Corresponding components have the same reference numbers. In this embodiment of the invention there are eight plasma/catalyst modules 110 instead of three, but otherwise the two embodiments of the invention are the same.

In the two arrangements described above, if any of the inner metallised ceramic tubes 128 fails, then the remainder no longer present a quasi-continuous electrode to the outer envelope 123 of the plasma section of the plasma/catalyst module 110 concerned and that module will fail, but the operation of the others will be unaffected. Disconnection of a failed module will allow the remaining modules to operate.

Referring to FIG. 4, there is shown a longitudinal section of a third embodiment of the invention. Those components which are similar to corresponding components of the embodiments of the invention described above have the same reference numerals.

Again there is provided a reactor chamber 100 which has inlet and outlet stubs 102, 103 by which it can be connected into the exhaust system of an internal combustion engine. As before, the reactor chamber 100 is in two sections 104, 105 joined together by means of flanges 106, 107.

In this embodiment of the invention, the central duct 109 is a tube 401 made of stainless steel which is perforated over the major portion of its length. At the downstream end of the tube 401 there is a butterfly diverter valve 119 as before. The tube 401 is surrounded by three continuous beds 402, 403 and 404 of active material each of which is contained within stainless steel tubes 405, which are perforated over the major portion of their lengths. The outer containment tube of one bed of active material forms the inner containment tube of the next bed of active material.

The innermost containment tube 405 is so shaped that over the major portion of its length there is a gap 406 between it and the central tube 401. The upstream end of the section 104 of the container 100 projects radially from the central tube 401 and the containment tubes 105 butt against it. The downstream ends of the containment tubes 405 butt against and are held in place by a disk of alumina wool packing 406, which in turn is held in place by a closure lid 407 which is attached to a flange 408 formed on the downstream end of the outermost containment tube 405.

The first and second (radially outwards) containment tubes 405 are grounded to provide two ground potential grids which are equidistant from a cylindrical high voltage grid 409 located within the bed 402. The high voltage grid 409 is held in position by a plurality of ceramic insulating pillars 410, one of which, 411, is adapted to act as a high voltage feedthrough.

The bed 402 is filled with spheres or pellets of a dielectric material, that can include a ferroelectric material such as a titanate or a zirconate, which is catalytic for the combustion of particulate carbonaceous combustion products. The outer beds 403, 404 may be filled with the same material or different active materials or combinations of active materials. If different active materials are used, then for example the bed 403 may be made of a perovskite or vanadate material or of a metal-doped zeolite material and the bed 404 may be made of an activated alumina doped with silver or molybdenum or a metal-doped zeolite or metal oxide doped alumina.

The beds 403, 404 also may be in the form of spheres, pellets, extrudates, sheets, wafers, frits, meshes, coils, granules, membranes, foam, ceramic honeycomb monolith or as a coating on any of these shapes.

As before, initially the reactor is operated with the diverter valve 119 closed, constraining the exhaust gases to pass radially through the beds 402, 403, 404 of active materials before emerging to pass out of the reactor chamber 100 via the outlet stub 103 and then as the plasma bed 408 becomes choked with unoxidized carbonaceous combustion products, the diverter valve 119 is opened to permit the exhaust gases to pass directly through the central duct 109.

FIG. 5 shows another form of reactor embodying the invention. Referring to FIG. 5 in which, again, those components which correspond to similar components of the first embodiment have the same reference numerals, a reactor chamber 100 has inlet and outlet stubs 102 and 103 by means of which it can be incorporated into the exhaust system of an internal combustion engine. The chamber 100 is in two sections 104, 105 joined by sealed flanges 106, 107.

The inlet stub 102 communicates with a central duct 109 formed by a stainless steel tube 501 which has two perforated sections 502, 503 separated by a region 504 in which there is mounted a butterfly diverter valve 119. The downstream end of the tube 501 is supported by an annular web 505. Upstream of the butterfly valve 119 and extending over the perforated section 502 of the central tube 501 is a plasma bed 506 which consists of inner and outer perforated stainless steel containment tubes 507, 508 respectively. As with the previous embodiment, the inner containment tube 507 is lipped at the downstream end to provide a space between it and the central tube 501. Also as before, the upstream end of the plasma bed 506 is closed by abutment against a flat section of the upstream end wall of the section 104 of the reactor chamber 100 and the downstream end of the plasma bed 506 is closed by an annular end wall. About two thirds of the radial thickness of the plasma bed 506 there is situated a cylindrical stainless steel grid 509. The containment tubes 507, 508 and the intermediate grid 509 are all connected to an earthing point, not shown in the drawing, and form grounded electrodes.

In the centre of each part of the bed 506 there is a high-voltage grid 510 made of perforated stainless steel coated with a ceramic insulating material. Each grid 510 is mounted on ceramic supports 511 and is provided with a high-voltage feed-through 512. Each section of the bed 506 is filled with a dielectric material that can include a ferroelectric material. Suitable ferroelectric materials are titanates or zirconates. Thus the sections of the bed 506 act as two sequential dielectric barrier reactors.

Downstream of the diverter valve 119 there are two superimposed catalyst beds 513 and 514. The catalyst beds 513 and 514 extend along the perforated section 503 of the central tube 501 and are contained between the tube 501 and the perforated stainless steel tubes 515 and 516 and end plates 517 and 518.

As before, the catalyst beds 513 and 514 are both filled with materials which catalyse the reduction of nitrogen oxides, the outer bed 514 being filled with a material such as a perovskite, or metal-doped zeolite such as indium-doped ZSM5 which is more effective in the presence of plasma-excited species in the exhaust gases, and the inner bed being filled with a material such as silver or molybdenum doped γ alumina, which is more effective in the absence of plasma excited species in the exhaust gases. As before, the materials in the beds 513, 514 can be in the form of spheres, pellets, extrudates, sheets, wafers, frits, meshes, coils, granules, membranes, foam, ceramic honeycomb monolith or as a coating on any of these shapes.

Initially, the reactor is operated with the diverter valve 119 closed, when the gas flow pattern is as shown, but when the need arises, the diverter valve 119 is opened permitting the exhaust gases to pass directly through the tube 501 forming the central duct 109.

FIG. 6 shows longitudinal and transverse sectional means of another reactor embodying the invention for the treatment of the exhaust gases from an internal combustion engine.

The reactor shown in FIG. 6 has the same form as that shown in FIG. 5 and the catalyst section and flow diverter valve will not be described further. Again, the same reference numerals are used for corresponding components.

The plasma section of the reactor is in two concentric gas permeable beds 601, 602 contained within perforated stainless steel tubes 603, 604 and 605, one end wall 606 of the reactor chamber 100 and an annular end plate 607. As before, the beds 601, 602 are filled with a dielectric material that can include a ferroelectric material, such as a titanate or zirconate. Again, there is a gap between the innermost bed containment tube 603 and the perforated section 502 of the tube 501 forming the central duct 109 of the reactor. As in the embodiment described with reference to FIG. 5, the bed containment tubes 603, 604, 605 act as ground electrodes.

The high voltage grids 510 of the previously described embodiment of the invention, however, are replaced by two rings 607, 608 of adjacent ceramic tubes which are coated with a highly conductive metal on their inner surfaces. The two rings of metallised ceramic tubes 607, 608 are connected together in parallel by two power supply rings 609, 610 which are fed by a high voltage feed-through 611 which passes through a protective end-cap 612 attached to the end wall 604 of the section 104 of the reactor chamber 100. As in the first embodiment of the invention, the rings 607, 608 of metallised ceramic tubes act as single electrodes of dielectric barrier plasma generators.

The gas flow patterns with the diverter valve 119 closed and open are the same as for the previous embodiment of the invention.

FIG. 7 shows longitudinal and transverse sectional views of another reactor embodying the invention for the treatment of the exhaust gases from an internal combustion engine.

Again, the layout of the reactor is similar to that of the embodiments described with reference to FIGS. 5 and 6 and only those parts which differ will be described.

Referring to FIG. 7, the plasma region of the reactor upstream of the flow diverter valve 119 consists of sixteen dielectric barrier plasma generators 701 connected in parallel and fed via a high voltage supply ring 702 and a high voltage feed-through 703 which passes through an end cap 704 attached to the end-wall 705 of the section 104 of the reactor chamber 100. Note that the number of reactors for use is determined by the flow rate of the gaseous media, the concentration of emissions, the geometric space available for housing the reactor and the degree of remediation required.

Each dielectric barrier plasma generator 701 consists of a ceramic tube 706 which is closed at each end and metallised on its inner surface. The downstream end closure of the tube 706 is domed. As it is not the intention that the metallised ceramic tubes 706 should present a quasi-continuous electrode, they are of greater diameter than those used in previously described embodiments of the invention.

Two grounded perforated stainless steel cylinders 707 and 708 are concentric with the central duct 109 of the reactor and abut the end wall 705 of the section 104 of the reactor chamber 100 at one end, and an annular support member 709 at the other. The support member 708 has a series of depressions 709 which receive and locate the domed ends of the tubes 705. The space between the containment cylinders 707 and 708 is filled with pellets or beads of dielectric material that can include a ferroelectric material. The cylinders 707 and 708 act as grounded electrodes and the inner surface of the cylinder 707 also acts as part of the wall of the central duct 109.

The gas flow patterns with the diverter valve 119 closed, initially, and then opened when necessary are the same as for the previous two embodiments of the invention.

As each of the metallised tubes 706 acts as the high voltage electrode of a separate dielectric barrier plasma generator, this embodiment of the invention is modular in the sense that the failure of one tube 706 does not affect the operation of the remainder of the plasma section of the reactor.

FIG. 8 shows longitudinal and sectional views of another embodiment of the invention which is similar to that described with reference to FIG. 4 and similar reference numerals are used for similar components.

Referring to FIG. 8, the high voltage grid 409 of the embodiment of the invention described with reference to FIG. 4 is replaced by a ring of closely-spaced internally metallised ceramic tubes, 801, which project through the upstream end wall 802 of the section 104 of the reactor casing 100 via insulating feed-throughs 803. The tubes 801 are connected together in parallel by a high voltage supply ring 804 which passes through an end-cap 805 via a high-voltage feed-through 806.

As before, the tubes 801 are sufficiently close to act as a single quasi-continuous high voltage electrode of a dielectric barrier plasma generator, whilst allowing flow of gas therebetween.

The remainder of the reactor and its operation are the same as for the reactor described with reference to FIG. 4.

Convenient power supplies for the reactors are those adapted to provide a potential of the order of kilovolts to tens of kilovolts and repetition frequencies in the range of 50-5000 Hz, although higher frequencies of the order of tens of kilohertz can be used. Pulsed direct current and alternating potentials for example triangular or sine waves of the same or similar characteristics can be used.

The invention is not restricted to the details of the foregoing examples. For instance, for certain applications it may be advantageous to provide, instead of a single power supply unit supplying high voltage power to each plasma/catalyst module via cables 131, a separate high voltage power supply unit for each module. This would allow other modules to continue to operate if one module fails, without having to provide specifically for disconnection of a failed module. Furthermore, space constraint may be more easily accommodated in that a plurality of small spaces for individual power supply units for each module may be more readily provided than a single larger space for a single power supply unit.

1. A reactor for the plasma-assisted processing of effluent gases such as exhaust gases from an internal combustion engine or effluent gases from industrial processes or incineration to reduce the emission of noxious combustion products therefrom, comprising a reactor chamber adapted to be connected to a source of effluent gas and including a central axial duct at least a portion of which is gas permeable, a first gas permeable bed of a material adapted to perform a first stage treatment including where necessary the removal of carbonaceous combustion products from gases passing therethrough, the said first gas permeable bed surrounding the gas permeable region of the central duct, means for establishing a non-thermal plasma in gases in the interstices of the first gas permeable bed, and also surrounding the axial duct at least one other gas permeable bed of a material adapted to catalyse the reduction of nitrogen oxides in gases passing therethrough and a flow diverter adapted in one state to constrain gases to pass initially through the first region of active material surrounding the central duct and then through at least one other region of active material surrounding the central duct and in a second state to allow the gases to pass directly through the central duct of the reactor.

2. A reactor according to claim 1 wherein the at least one other gas permeable bed of a material adapted to catalyst the reduction of nitrogen oxides in gases passing therethrough is superimposed upon the first gas permeable bed of active material in a radial sense.

3. A reactor according to claims 1 and 2 wherein the said first gas permeable bed of active material is provided by a plurality of axially extending modules disposed regularly around the central duct and connected in parallel electrically.

4. A reactor according to claim 3 wherein the at least one other gas permeable bed of a material adapted to catalyst the reduction of nitrogen oxides in the gases passing therethrough also is modular in form each module being associated with a module of the plasma activated gas permeable bed

5. A reactor according to claim 1 wherein the at least one other gas permeable bed of a material adapted to catalyse the reduction of nitrogen oxides in gases passing therethrough is displaced axially with respect to the said first gas permeable bed.

6. A reactor according to any of claims 1 to 5 wherein the means for exciting a non thermal plasma in gases in the interstices of the first gas permeable bed comprises at least one linear array of internally metallised ceramic tubes connected in parallel, the said tubes being so spaced that they act as a single high voltage electrode of a dielectric barrier plasma generator, the containment of the first gas permeable bed being adapted to act as grounded electrodes of the plasma generator.

7. A reactor according to any of claims 1 to 5 wherein the means for exciting a plasma in gases in the interstices of the first gas permeable bed comprises at least one gas permeable electrode immersed in the material of the first gas permeable bed and means for applying to that electrode a voltage sufficient to excite a non-thermal plasma in the said gases, the containment of the first gas permeable bed being adapted to act as grounded electrodes.

8. A reactor according to claim 6 or 7 wherein there are at least two high-voltage electrodes separated by grounded gas permeable electrodes.

9. A reactor according to any of claims 1 to 5 wherein the means for exciting a non-thermal plasma in gases in the interstices of the first bed of active material comprises a plurality of axially oriented dielectric barrier plasma generators disposed regularly around the periphery of the central duct and immersed in the first bed of active material.

10. A reactor according to claim 9, wherein a separate high voltage power supply unit is provided for each of the said plurality of plasma generators.

11. A reactor according to any of claims 5 to 10 wherein the flow diverter is situated between the first gas permeable bed and the at least one other gas permeable bed of a material adapted to catalyse the reduction of nitrogen oxides in gases passing therethrough and is adapted when closed to cause the gases to pass initially through the said first bed of active material and then through the at least one other such bed of active material.

12. A reactor according to any of claims 2 to 4 or 6 to 11 wherein the flow diverter is adapted when closed to cause the gases to pass initially through the said first bed of active material and then through the said at least one other bed of active material radially.

13. A reactor according to claim 1 for the treatment of emissions from incinerators and emissions from pharmaceutical, food processing, paint manufacturing, dye manufacturing, textile and printing industries.
